(19) United States
(12) Patent Application Publication
(10) Pub. No.: US 2010/0105356 A1
(43) Pub. Date: Apr. 29, 2010

(54) Secure mobile communication system

(76) Inventors: Ohannes Deir Ghazarian, Henderson, NV (US); Tracy Lynn Anton, Barrington, IL (US)

Correspondence Address: Ohannes Deir Ghazarian, 2575 W. Horizon Ridge Pkwy No. 1611, Henderson, NV, 89052, US

(21) Appl. No.: 12/589,703

(22) Filed: Oct. 26, 2009

Related U.S. Application Data
(60) Provisional application No. 61/197,652, filed on Oct. 29, 2008.

(51) Int. Cl. H04W 12/00

(52) U.S. Cl. 455/410

(57) ABSTRACT

Secure mobile communication system comprises of a mobile communication device having a processor, a RF transceiver to establish mobile voice communication and receive and send text or email messages, an alphanumeric keypad is used for dialing phone numbers or creating text or e-mail messages, the mobile communication device RF transceiver or a receiver is designed to receive RF signals from a vehicle mount RF transmitter or transceiver device, the a vehicle mount RF transmitter or transceiver device transmitting RF coded signals when vehicle ignition is in on position and or when vehicle is in motion.

The mobile communication device of present invention upon receipt of vehicle mount device RF transmitted signals, the mobile communication device keypad becomes none operative for user not be able to dial up phone calls and or send or receive text messages or e-mails. In a preferred embodiment of invention vehicle mount RF transmitter transmitted signals radiated towards the driver compartment proximity, thus the teaching restricts the driver using a mobile communication device but allows the vehicle passenger(s) to use mobile communication device keypads and visual screens.

### BACKGROUND OF THE INVENTION

### Field of the Invention

In the pass many different method has been used to provide safety mobile communication devices to avoid driver distraction such as hands free cellular phones using an attachable head set having a speaker and a microphone which provides to the driver the ability to use both hands to operate a vehicle. Another useful method has being use to provide driver safely to use mobile phone operation by use of speech dialing method, in this case vehicle driver gives speech command such as call recipient name accordingly the mobile phone processor base on received speech command converts analogue into digital DTMF data and creates a phone call without driver using the keypad to avoid driver becoming distracted during driving.

Even though prior art teaching found to be useful in the art, but none of the prior art teaching provides safe use of mobile communication device since it is common knowledge most vehicle drivers in many occasion still use mobile communication device keypad to make phone calls or even use the keypad to compose text or e-mails.

Perhaps another useful method has been used to avoid vehicle driver to become distracted, a mobile communication device is been used having a built-in GPS receiver used for to determine vehicle speed and based on vehicle speed the mobile communication device becomes not operative for user be able to make phone calls or send and receive text or e-mail messages to avoid driver distraction.

Unfortunately such a teaching restricts the driver and the passenger(s) of the vehicle the use of such mobile communication devices wile vehicle is in motion, contrary to present invention teaching which will restrict the use of mobile communication device only to the driver of the vehicle to avoid driver distraction but allows the vehicle passenger to use there mobile communication device, which teaches a definite improvement in the art.

Accordingly it is the primary objective of the present invention to utilize a secure mobile communication system which comprises of a mobile communication device having a processor, an RF transceiver to establish mobile voice communication and receive and send text or email messages, an alphanumeric keypad used for dialing phone numbers or create text or e-mail messages, and a vehicle mount RF transmitter or transceiver device used for transmitting RF coded signals which transmits coded RF signal in response to received vehicle ignition signal and or receives vehicle speed signals from said vehicle speedometer, accelerometer or vehicle mount GPS unit and or when an RF communication is established between the vehicle RF transceiver device and the mobile communication device. The mobile communication device of present invention upon receipt of vehicle mount RF transmitter device transmitted signals the mobile communication device keypad becomes none operative for the driver to not able to dial up phone calls and or send or receive text messages or e-mails.

It is another objective of the present invention that the vehicle mount RF transmitter transmitted signals to be directional and cover the driver seat position proximity, thus the teaching only restricts the driver to the use of mobile communication device but it allows the vehicle passenger(s) to use mobile communication device keypads to dial up calls or to send text and or e-mails, or view the visual screen for text or e-mail data.

It is another objective of the present invention that when the mobile communication device upon receipt of the vehicle mount RF transmitter coded signals the mobile communication device becomes operative by user voice speech recognition to establish phone calls, or compose text or emails, and convert received text or e-mail data into digitally synthesized voice message play to the driver.

It is another objective of present invention that the mobile communication device of the present invention upon receipt of vehicle mount generated RF coded signals the device becomes completely inoperative until vehicle ignition is turned off or vehicle becomes not in motion.

It is further objective of present invention that the mobile communication device of the present invention additional my utilize a secondary RF receiver or a transceiver (transponder) circuitry designed to receive vehicle RF transmitter or an RF transceiver (Transponder interrogator) transmitted signals which upon receipt of the secondary RF signal(s) the keyboard function becomes none functional to dial up or compose or view text and e-mails on the device screen.

It is further objective of the present invention wherein it utilizes a vehicle mount RF transmitter device, the RF transmitter device processor transmits RF signals in response to received vehicle speed detection signals from vehicle speedometer (accelerometer) or vehicle mount GPS receiver device speed detection signals, and the mobile communication device upon receipt of RF transmitted signals becomes inoperative until vehicle sees moving.

And it is further objective of the present invention wherein it utilizes a mobile communication device contains an RF receiver to receive vehicle mount RF transmitter device transmitted RF signals and the mobile communication device contains a GPS receiver used for to determine vehicle speed condition, the mobile communication device in response to received vehicle RF transmitter device transmitted signals and received vehicle GPS speed signals, the mobile communication device keypad becomes none operative for the driver not be able to dial up phone calls and or send or receive text messages or e-mails.

### SUMMARY OF THE INVENTION

The present invention teaching provides safe mobile communication device for the driver of a vehicle not to get distracted, as found in the present invention wherein when a vehicle ignition is turned on and or vehicle becomes in motion, the vehicle mount RF transmitter device transmits RF coded signals which is received by vehicle driver mobile communication device which upon receipt of RF transmitted signals the mobile communication device keypad and or visual screen becomes not operative, to restrict the driver to use mobile communication device keypad to dial up a call, compose or receive text message, and or e-mails which causes driver distraction creating unsafe vehicle driving condition.

Accordingly it is the primary objective of the present invention to utilize a secure mobile communication system which comprises of a mobile communication device having a processor, an RF transceiver to establish mobile voice communication and receive and send text or email messages, an alphanumeric keypad used for dialing phone numbers or create text or e-mail messages, and a vehicle mount RF transmitter or transceiver device is used for transmitting RF coded signals, which transmits coded RF signal in response to received vehicle ignition signal and or receives vehicle speed or motion signals or when a communication is established between the vehicle RF transmitter device and mobile communication device, the mobile communication device of the present invention upon receipt of vehicle mount device RF transmitted signals the mobile communication device keypad becomes not operative for the user be able to dial up phone calls and or send or receive text messages or e-mails.

It is an objective of the present invention that the vehicle mount RF transmitter transmitted signals to be directional and cover the driver seat position radius, thus the teaching found in the present invention only restricts the driver not able to use mobile communication device but allows the vehicle passenger(s) to use mobile communication device keypads to dial up a call to send text and or e-mails, or view the visual screen for text or e-mail data.

It is another objective of the present invention that when the mobile communication device upon receipt of the vehicle mount RF coded transmitted signals the mobile communication device becomes operative by driver voice speech recognition to establish phone calls, or compose text or emails, and convert received text or e-mail data into digitally synthesized voice message play to the driver.

It is further objective of present invention that the mobile communication device of the present invention upon receipt of vehicle mount generated RF coded signals the device becomes completely inoperative until vehicle ignition is turned off or vehicle becomes not in motion.

It is further objective of present invention that the mobile communication device of the present invention additional my utilize a secondary RF receiver or a transceiver (transponder) circuitry designed to receive vehicle RF transmitter or an RF transceiver (Transponder interrogator) transmitted signals which upon receipt of the secondary RF signal(s) the keyboard function becomes none functional to dial up or compose or view text and e-mails on the device screen.

And it is further objective of the present invention that utilizes a safety mobile communication system wherein the vehicle mount RF transmitter device transmits RF signals in response to vehicle speed detection signals from vehicle speedometer, accelerometer, or vehicle mount GPS receiver device speed detection signals, or based on vehicle motion detection signals and accordingly the mobile communication device becomes inoperative until vehicle ignition is turned off or vehicle sees moving.

And it is further objective of present invention that the mobile communication device may contains a built-in GPS receiver to determine vehicle speed condition, the mobile communication device in response to received vehicle RF transmitter device transmitted signals and received vehicle GPS speed signals, the mobile communication device keypad and or visual alphanumeric screen functions becomes none operative for the driver not be able to dial up phone calls and or send or receive text messages or e-mails.

### DESCRIPTION OF THE DRAWINGS

FIG. 1 Describes a drawing of a vehicle interior having a driver and passenger compartment both compartments are covered with vehicle mount RF transmitter generated signals

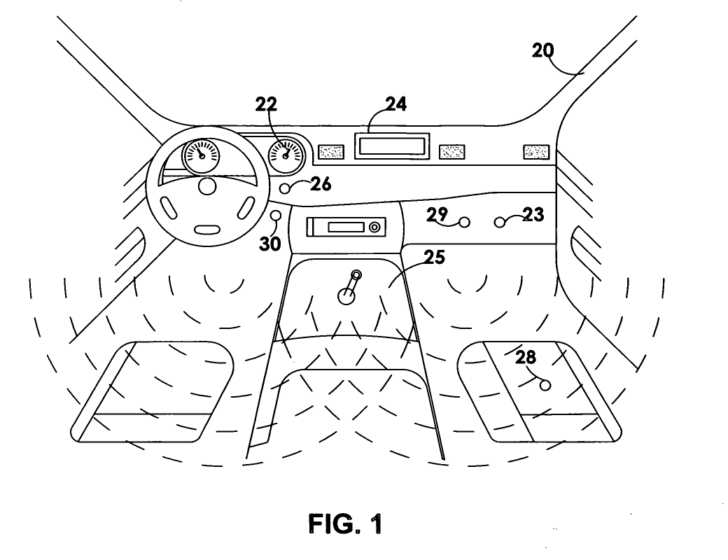

FIG. 2 Describes a drawing of a vehicle interior having a driver and a passenger compartment, the driver compartment covered with a blanket of RF signals generated by the vehicle RF transmitter device, passenger area is free from the RF signals.

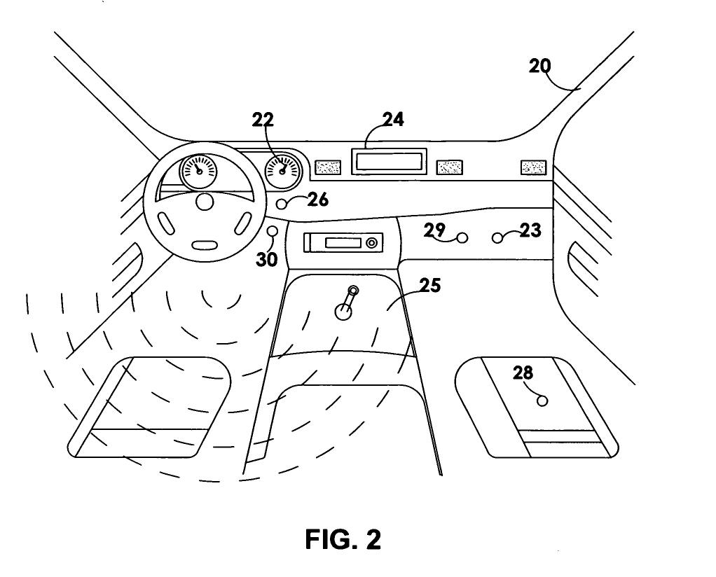

FIG. 3 Describes block diagram of the invention.

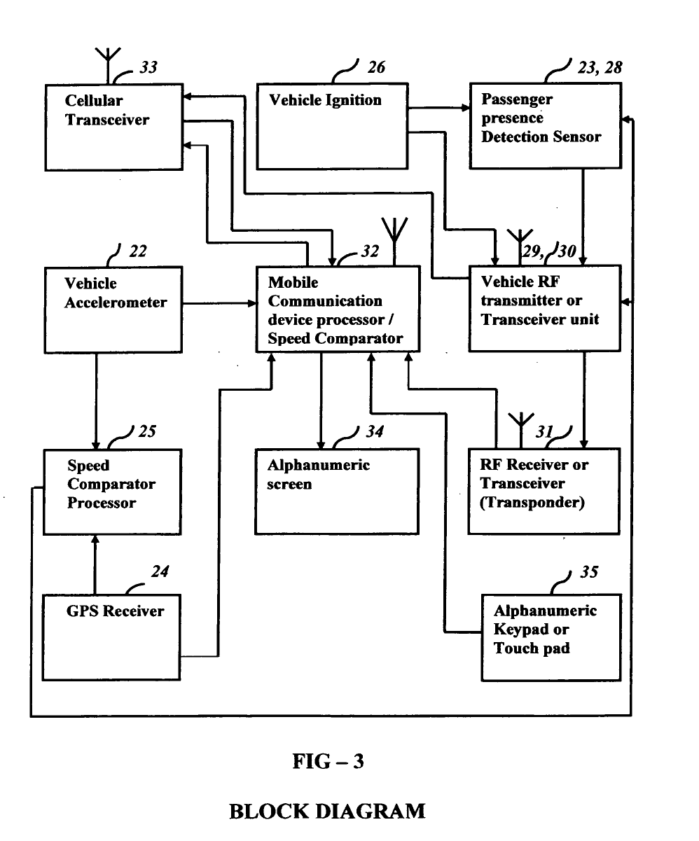

### DETAILED DESCRIPTION OF THE

### Preferred Embodiment

Secure mobile communication system comprises of a mobile communication device having, a processor 32, and an RF transceiver 33 to establish mobile voice communication and or to receive and send text or email messages, and
a alphanumeric keypad used for dialing phone numbers and or used for creating text or e-mail messages, and a visual screen to view said alphanumeric letters.
a vehicle mount RF transmitter or transceiver device 29, 30 used for transmitting RF coded signals covering the vehicle interior, the RF transmitter device transmits RF coded signals in response to received vehicle ignition 26 condition signals and or in response to receives vehicle speed detection signals 22, 25 and or in response to establishing RF communication with the mobile communication device 31,
the mobile communication device 32 of present invention upon receipt of vehicle mount RF transmitter device transmitter RF signals 29, 30, the mobile communication device keypad 35 becomes none operative so the driver of the vehicle may not be able to dial up phone calls and or send or receive text messages or e-mails.

In a preferred embodiment of the invention the vehicle mount RF transmitter 30 transmitting RF signals or the transmitted RF signals may be electromagnetic field signals radiating towards driver location proximity to restrict vehicle driver to use a mobile communication device 32 located within the driver compartment proximity, since the RF transmitter signals are not aimed towards passenger compartment the mobile communication devices 32 located within passenger compartment are fully functional for vehicle passengers to use their mobile communication device 32.

In a further embodiment of the present invention the vehicle mount RF transmitter device 32 additionally contains secondary RF transmitter(s) 29 radiating RF transmitted signals towards passenger(s) compartment, and the vehicle RF transmitter device additionally utilizes passenger compartment sensors 23 which may be optical sensors or thermo sensors, or a video image sensors and the sensors may be a seat pressure sensor 28 used to detect the presence of a passenger(s), the sensors 23, 28 upon detecting the presence of a passenger(s) within the vehicle passenger compartment, the vehicle secondary RF transmitter device 29 stops transmitted the RF coded signals radiating towards passenger compartment, thus mobile communication devices located within passenger compartment becomes operative for vehicle passenger(s) to use their mobile communication device(s).

In a preferred embodiment of the present invention wherein the mobile communication device 32 contains a speech recognition circuitry used for voice command phone dial up and for composing text or e-mails, and a voice synthesized circuitry is used for play back received text or e-mail messages, the mobile communication device 32 upon receipt of vehicle RF transmitter device 29, 30 transmitted signals the mobile communication device 32 becomes operative to driver voice speech commands so the driver may dial up phone calls, or compose text or emails, and additionally the mobile communication device may convert received text or e-mail data information into digitally synthesized voice play back for the driver, to ascertain driver safe usage of the mobile communication device 32.

The mobile communication device 32 of the present invention additionally my utilize a secondary RF receiver or a transceiver (transponder) 31 circuitry designed to receive vehicle RF transmitter or RF transceiver (Transponder interrogator) 29, 30 transmitted signals, which upon receipt of the secondary RF signal(s) the mobile communication device keyboard 35 function becomes none functional to dial up calls or compose or view text and e-mails on the device alphanumeric screen 34.

The present invention vehicle mount RF transmitter device 29, 30 transmits RF signals in response to vehicle mount speed comparator 25 or vehicle mount GPS receiver device 24 speed detected signals, the driver mobile communication device becomes inoperative until vehicle ignition 26 is turned off or vehicle sees moving.

In a further embodiment of the present invention wherein the mobile communication device 32 contains a built-in GPS receiver a processor to determine the vehicle speed condition, and in response to received vehicle RF transmitter device 29, 30 transmitted signals, the mobile communication device keypad 35 becomes none operative for the driver not be able to dial up phone calls and or send or receive text messages or e-mails.

What is claimed is:

1- Secure mobile communication system comprises of a mobile communication device having,
a processor, and an RF transceiver to establish mobile voice communication and or to receive and send text or email messages, and
a alphanumeric keypad used for dialing phone numbers and or used for creating text or e-mail messages, and a visual screen to view said alphanumeric letters,
a vehicle mount RF transmitter or transceiver device used for transmitting RF coded signals covering said vehicle interior proximity, said RF transmitter device transmits said RF coded signals in response to received vehicle ignition condition signals and or in response to receives vehicle speed detection signals, and or in response to establishing RF communication with said mobile communication device,
said mobile communication device upon receipt of said RF transmitted signals, said mobile communication device keypad and or visual alphanumeric screen becomes not operative for the driver of said vehicle not able to dial up phone calls and or send or receive text, messages or e-mails.

2- Secure mobile communication system as claimed in claim 1 wherein said vehicle mount RF transmitter transmitted signals radiating towards driver compartment proximity to restrict vehicle driver to the use of a mobile communication device located within said driver location proximity, and mobile communication devices located within said vehicle passenger compartment in response to not receiving said RF transmitted signals said passengers mobile communication device (s) are operative to said vehicle passengers.

3- Secure mobile communication system as claimed in claim 2 wherein said RF transmitter(s) radiating said RF transmitted signals towards driver and passenger(s) compartment used for said driver not be able to position said mobile communication device into the proximity of said vehicle passenger compartment and operate said mobile communication device,
said vehicle RF transmitter device additionally utilizes passenger compartment sensors used to detect the presence of a passenger(s), said sensors upon detecting the presence of passenger(s) within said vehicle passenger compartment, said vehicle RF transmitter device reduces said RF transmitted signals strength to cover said vehicle driver location proximity, to allow vehicle passenger(s) to use said mobile communication device(s) located within passenger compartment.

4- Secure mobile communication system as claimed in claim 2 wherein said vehicle mount RF transmitter device additionally contains secondary RF transmitter(s) radiating said RF transmitted signals towards passenger(s) compartment used for said vehicle driver not be able to position said mobile communication device into the proximity of said vehicle passenger compartment and operate said mobile communication device, said vehicle RF transmitter device additionally utilizes passenger compartment sensors used to detect the presence of a passenger(s), said sensors upon detecting the presence of passenger(s) located within said vehicle passenger compartment, said vehicle secondary RF transmitter device stops transmitted said secondary RF signals radiating towards passenger compartment, to allow vehicle passenger(s) to use said mobile communication device(s) located within passenger compartment.

5- Secure mobile communication system as claimed in claim 1 wherein said mobile communication device additionally contains a speech recognition circuitry used for speech command phone dial up and for composing text or e-mails, and or contains a voice synthesized circuitry used for playing back received text or e-mail messages, said mobile communication device upon receipt of said vehicle RF transmitter device transmitted signals said mobile communication device becomes operative to driver voice speech commands to dial up phone call(s), and or compose text or emails, and or convert said received text or e-mail data information into digitally synthesized voice play back to avoid driver distraction.

6- Secure mobile communication system as claimed in claim 1 wherein said mobile communication device of the present invention upon receipt of vehicle mount generated RF coded signals said mobile communication device becomes inoperative until vehicle ignition is turned off or vehicle sees moving.

7- Secure mobile phone communication system as claimed in claim 1 wherein said mobile communication device additionally my utilize a secondary RF receiver or a transceiver (transponder) circuitry designed to receive vehicle RF transmitter or RF transceiver (Transponder interrogator) device transmitted signals, said mobile communication device upon receipt of said secondary RF signal(s) said mobile communication device keyboard function becomes none functional for driver to dial up calls or compose or view text and e-mails on said mobile communication device screen.

8- Secure mobile communication system as claimed in claim 1 wherein said vehicle mount device transmits RF signals in response to receiving said vehicle mount speedometer or vehicle accelerometer speed detection signals, or vehicle mount GPS receiver device speed detection signals said mobile communication device upon receipt of said RF transmitted signals said mobile communication device becomes inoperative until said vehicle stop moving.

9- Secure mobile communication system as claimed in claim 1 wherein said mobile communication device contains a built-in GPS receiver a processor to determine said vehicle speed condition, and accordingly in response to received vehicle RF transmitter device transmitted signals and received GPS vehicle speed signals, said mobile communication device keypad becomes none operative for the driver of said vehicle not be able to dial up phone calls and or send or receive text messages or e-mails.
